(19) United States
(12) Patent Application Publication
(10) Pub. No.: US 2017/0045955 A1
(43) Pub. Date: Feb. 16, 2017

(54) Computing Device

(71) Applicant: HEWLETT-PACKARD DEVELOPMENT COMPANY, L.P., HOUSTON, TX (US)

(72) Inventor: Chien-Kuo Lee, Taipei City (TW)

(73) Assignee: Hewlett-Packard Development Company, L.P., Houston, TX (US)

(21) Appl. No.: 15/118,567

(22) PCT Filed: Mar. 28, 2014
(86) PCT No.: PCT/US2014/032194

§ 371 Date: Aug. 12, 2016

(51) Int. Cl. G06F 3/03; G06F 3/041; G06F 1/16

(52) U.S. Cl. CPC G06F 3/0304; G06F 1/1643; G06F 1/1616; G06F 3/041

(57) ABSTRACT

A computing device includes a base member, an input device attached to the base member and a display member connected to the base member. A sensor is attached to the base member and a controller adjusts input sensitivity of the input device when the sensor detects an object close to the display member.

### BACKGROUND

Computing devices such as laptop computers, desktop computers and tablet computers, often have a touch sensitive screen (‘touch screen’ or ‘touch display’) which can receive user input. Many such computing devices also have a separate input device, such as a physical keyboard and/or a trackball, touchpad or mouse.

### BRIEF DESCRIPTION OF THE DRAWINGS

Examples of the disclosure will now be described, by way of non-limiting example only, with reference to the accompanying drawings, in which:

FIG. 1 is a perspective view of an example of a computing device according to the present disclosure;

FIG. 2 is a perspective view of an example of a computing device according to the present disclosure;

FIG. 3 is a method diagram for a computing device according to the present disclosure;

FIG. 4 is a perspective view of an example showing a computing device and virtual wall according to the present disclosure;

FIG. 5 is a side view of an example showing a computing device and virtual wall according to the present disclosure; and

FIG. 6 is a block diagram of a computing device according to the present disclosure.

### DETAILED DESCRIPTION

Touch screens provide a convenient and intuitive way for users to interact with a computer device. A user is able to select user interface objects by tapping the touch screen and/or performing other gestures to select items or perform certain actions. Many popular operating systems are programmed to accept input via touch gestures on a touch screen.

Using the touch screen for input is not always convenient, especially for tasks such as typing large amounts of text. Therefore, computer devices with touch displays often have an additional input device, such as a physical keyboard, mouse, touchpad or trackball etc.

When interacting with a touch display screen a user has to lift them arm above a keyboard, or other input device, to touch the screen. The present disclosure proposes a sensor and a controller to adjust input sensitivity of the input device when the sensor detects an object, such as a hand of a user, close to the display. In this way if a user gets tired and rests his or her arm or wrist on the keyboard or other input device, they can do so safely without accidentally inputting signals to the computer device. This may help to alleviate the phenomena known as “gorilla arm” which refers to the fatigue some users encounter when interacting continuously with a touch display over a prolonged period.

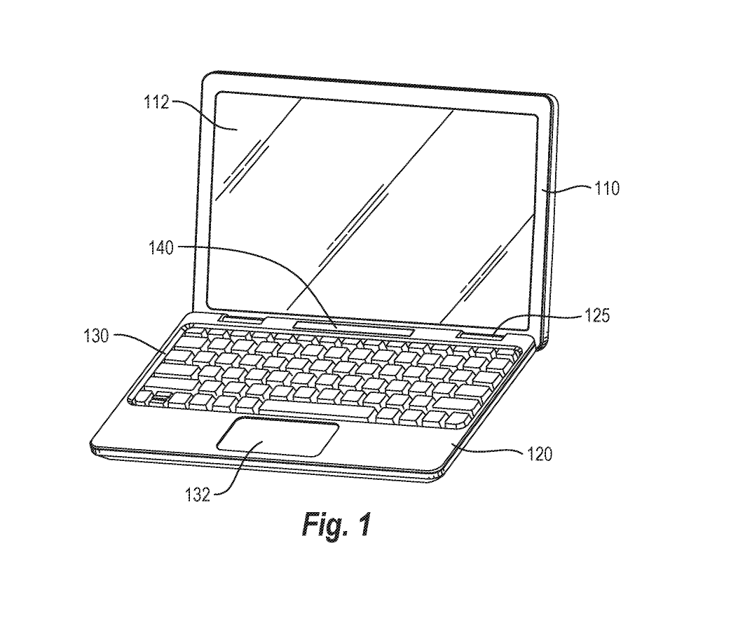

FIG. 1 shows an example computer device 100. The device includes a display member 110 connected to a base 120. The display member may be connected to the base by any way which allows signals from the base to be received by the display member. For example there may be a wired or wireless connection. In addition, the display member may be mechanically attached to the base. Generally the mechanical connection will be such that the display member upwardly at an angle relative to the base, for instance the display member may be rotably attached to the base by a hinge or otherwise, or may fit into a slot in the base or have a releasable attachment to the base.

The display member 100 includes a screen 112 for displaying images generated by the computer device. The screen 112 may be a touch sensitive screen (commonly known as a ‘touch display’).

The base 120 includes a keyboard 130 and a trackball or touchpad 132, which are examples of input devices. In other examples the base 120 may have only one input device or more than two input devices. In the following the keyboard 130 will be referred to as ‘the input device’ for ease of reference. However, it is to be understood that in other examples ‘the input device’ may be a touchpad, trackball or other type of input device on the base.

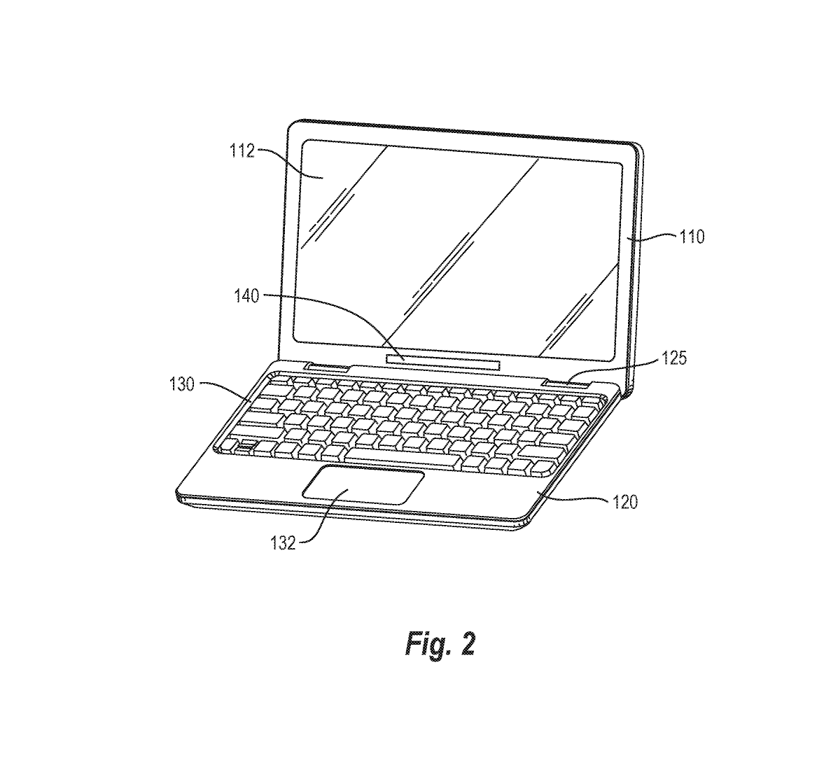

A sensor 140 is arranged to detect presence and movement of an external object, for instance the external object may be a body part of a user, such as a users hand. The sensor 140 may for example be an optical sensor and in some examples may be a 3D motion sensor. The sensor may be situated on the base 120 of the computing device. In the example shown in FIG. 1 the sensor is located on the base 120 between the input device 130 and a junction 125 of the base with the display member. In another example, shown in FIG. 2 which is otherwise the same as FIG. 1, the sensor 140 may be located on the display member 110.

There are various considerations when considering where to locate the sensor 140, including the best position for detecting movement of a user's hand towards the display member, the size of the sensor and space available and aesthetic considerations. The base 120 may in some cases have more room than the frame surrounding the display member, which may allow for a larger or more sophisticated sensor.

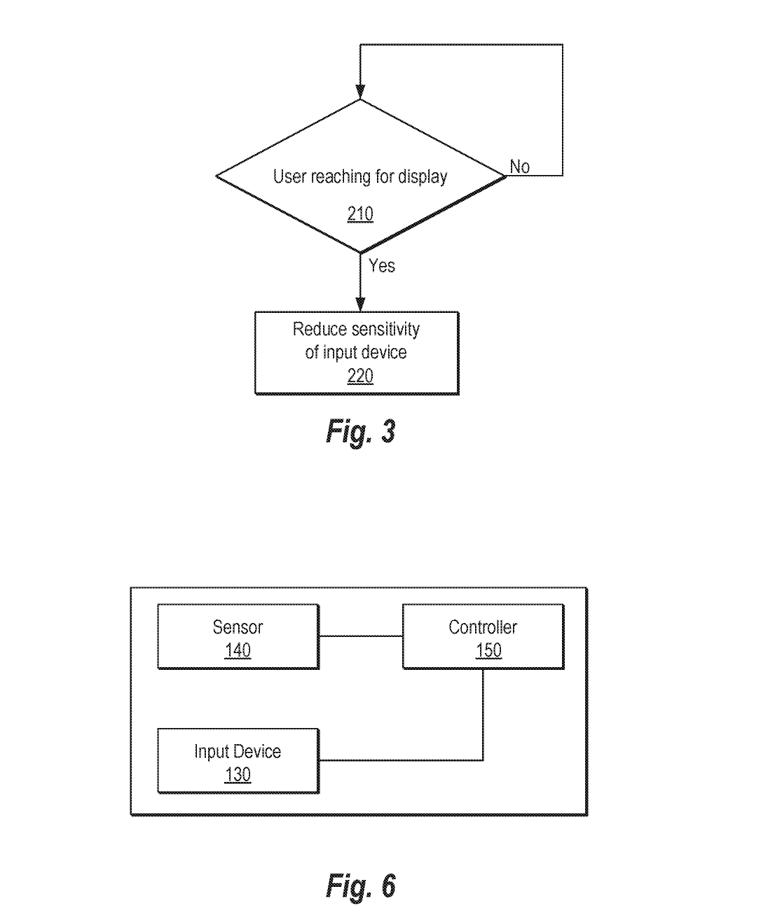

A controller (not shown in FIG. 1 or 2) adjusts the sensitivity of the input device 130 in response to the sensor detecting an object close to the display member 100. FIG. 3 shows an example method flow of the controller. At 210 the controller determines whether or not the sensor has detected a user reaching for the display.

For example the sensor 140 may an object close to the display member 100. For example, this detection may be based on an object entering a predefined volume of space in the vicinity of the display member. In one example the the sensor may detect an object approaching within a predetermined distance of the display member. In another example the sensor may detect when an object passes a particular line on the base of the computing device, or when an object passes a “virtual wall” which is discussed in more detail below.

In some examples the sensor may be able to detect when the object is a hand of the user, i.e. it may be able to distinguish a user's hand from other objects and thus in some examples the controller may be configured to reduce the sensitivity of the input device when the detected object is a user's hand. In some examples the sensor may be able to detect when a user's hand reaches for the display member, i.e. it may be able to detect a hand and reaching movement of the hand towards the display member. Thus in some examples the controller may be configured to reduce the sensitivity of the input device when the sensor detects a user's hand reaching for the display member. In other examples the controller may be simply to reduce the sensitivity of the input device in response to the sensor detecting any object close to the display member.

At 220 the controller adjusts the sensitivity of the input device 130 in response to the sensor detecting an object as described above. For example the controller may reduce the sensitivity of the input device 130, by turning off or inactivating the input device. This may, for example, be achieved by powering down the input device, preventing the input device from sending signals, instructing the CPU (Central Processing Unit) or OS (Operating System) of the computer device to ignore signals from the input device etc.

As mentioned above, the ‘input device’ is an input device on the base 120 such as a keyboard, touchpad, trackball etc. If a plurality of input devices are on the base, then one, several, or all of the input devices may have their sensitivity reduced in response to the sensor detecting a user reaching for the display member.

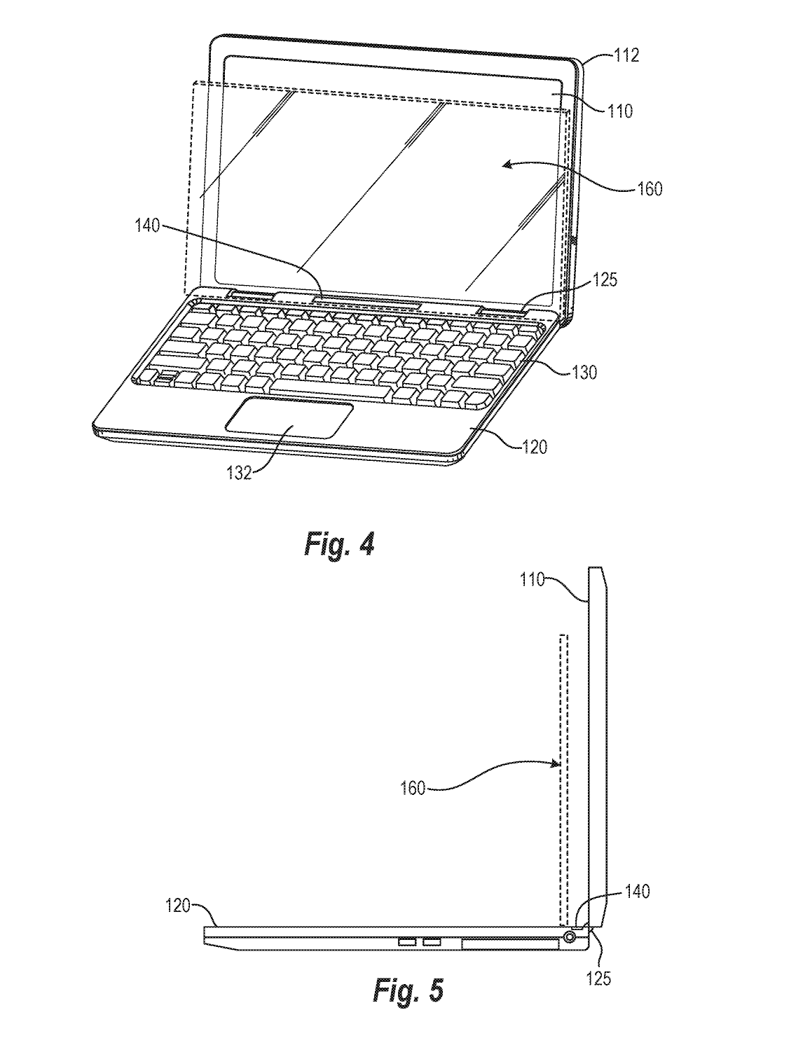

In one example, the sensor 140 may be configured to detect when an object passes a “virtual wall”. Examples of a virtual wall 160 are shown in FIGS. 4 and 5. FIG. 4 is a perspective view similar to FIGS. 1 and 2, while FIG. 5 is a side view. The virtual wall 160 is not a physical wall, but rather a notional plane configured in the sensor or computing device software or firmware so that it can be determined when a sensed body part passes the wall. For example the virtual wall 160 may extend upwardly from the base 120 of the computer device. In some examples the virtual wall 160 may be implemented in software or firmware running on the computing device and/or integrated into the sensor or controller.

In one example the sensor 140 is a 3D motion sensor which is able to detect and track 3D motion of an object, such as a hand or a user. For example, together with the controller or other processor, the 3D motion sensor may be able to determine the position of an external object in 3 dimensions. In one example the motion sensor may comprise a camera and an infrared light source, such as an infrared LED. In some examples there may be two video cameras and a plurality of infrared light sources. The infrared light source may project light onto the external object, e.g. a hand of the user, and the video camera may detect visible ambient light and/or infrared light reflected from the object. This information may be sent to a processor which builds a model to track the position and motion of the object based on this information. Hewlett-Packard's “Leap Motion” technology is one example of a 3D motion sensor. It is convenient to mount the 3D motion sensor on the base of the computing device, for reasons of space, but it would also be possible to mount it elsewhere, such as on the display member. In either case, the 3D motion sensor can detect an object approaching close to the display member by tracking movement of the object in three dimensions.

FIG. 6 is a schematic diagram showing parts of the computer device. The computer device includes an input device 130, a sensor 140 and a controller 150. The controller 150 is in communication with the sensor 140 and the input device 130. The controller may for example be a Central Processing Unit (CPU) of the computing device, a separate dedicated processor, a processor integrated with the sensor or a combination of the aforementioned. The controller 150 receives input from the sensor 140 and implements the method illustrated in FIG. 3. In some examples the controller may may analyze data received from the sensor in order to determine if an object approaches close to the display member.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A computing device comprising:
a base member; an input device attached to the base member;
a display member connected to the base member;
a sensor attached to the base member;
a controller to adjust input sensitivity of the input device when the sensor detects an object close to the display member.

2. The computing device of claim 1 wherein the controller is to adjust input sensitivity of the input device when the sensor detects a hand of a user reaching for the display member.

3. The computing device of claim 1 wherein the controller is to detect when an object passes a virtual wall between the input device and the display member.

4. The computing device of claim 1 wherein the input device is a keyboard.

5. The computing device of claim 1 wherein the sensor is an optical sensor.

6. The computing device of claim 1 wherein the controller is to adjust input sensitivity by turning off the input device or causing the computing device to ignore signals from the input device.

7. A computing device comprising a keyboard and a touch display connected to the keyboard; an optical sensor to detect when an object comes within a predetermined distance of the touch display and a controller to inactivate the keyboard in response to the sensor detecting that an object is within a predetermined distance of the touch display.

8. The computing device of claim 7 wherein the optical sensor comprises two cameras arranged to detect movement of track movement of an object in 3 dimensions.

9. The computing device of claim 7 wherein the keyboard is positioned on a base of the computing device and the touch display is connected to the base and capable of adopting a position in which it extends upwardly relative to the base; and wherein the sensor is on the base and wherein the sensor is to detect an object moving over the base towards the touch display.

10. The computing device of claim 7 wherein the controller is to turn off the keyboard in response to the sensor detecting that an object is within a predetermined distance of the touch display.

11. The computing device of claim 7 wherein the controller is to disregard signals from the keyboard in response to the sensor detecting that an object is within a predetermined distance of the touch display.

12. A laptop computer comprising a base member and a display member rotably attached to the base member; wherein the base member includes a keyboard and the laptop computer further comprises a sensor to detect when an object passes a virtual wall separating the keyboard from the display member; and a controller to inactivate the keyboard in response to detecting that an object has passed through the virtual wall separating the keyboard from the display member.

13. The laptop computer of claim 12 wherein the sensor is an optical sensor located in the base member at a location between the keyboard and a junction of the base member and the display member.

14. The laptop computer of claim 12 wherein the sensor is a 3D motion tracker.

15. The laptop computer of claim 12 wherein the 3D motion tracker comprises an infrared LED and a video camera to detect an object and infrared light from the LED reflected off the object.
